(19) United States
(12) Patent Application Publication
(10) Pub. No.: US 2016/0158585 A1
(43) Pub. Date: Jun. 9, 2016

(54) Electromagnetic Fire Control System

(71) Applicants: Glenn Shevach, Toms River, NJ (US); Marco Tedeschi, Toms River, NJ (US); William Leach, Shamong, NJ (US)

(72) Inventors: Glenn Shevach, Toms River, NJ (US); Marco Tedeschi, Toms River, NJ (US); William Leach, Shamong, NJ (US)

(73) Assignee: United States of America as represented by the Secretary of the Navy, Patuxent River, MD (US)

(21) Appl. No.: 14/563,247

(22) Filed: Dec. 8, 2014

(51) Int. Cl. A62C 2/00

(52) U.S. Cl. CPC A62C 2/00

(57) ABSTRACT

An electromagnetic fire control system that includes a conductive surface and a power source such that the power source supplies power so that the conductive surface generates an electric field, the electric field is manipulated and interacts with a fire such that the fire is controlled.

### STATEMENT OF GOVERNMENT INTEREST

The invention described herein may be manufactured and used by or for the Government of the United States of America for governmental purposes without payment of any royalties thereon or therefor.

### BACKGROUND

As long as there has been fire, man has strived to control it in order to mitigate its obvious harmful effects. Current fire control or suppression/extinguishing systems typically include an agent, a container for the agent, and a control system of some sort to allow the release of the agent.

Typical operation of a fire control system includes: a fire is detected; the fire suppression system is activated; the agent is released from a container into the area of the detected fire; and emptying the container.

The ultimate effectiveness of any fire suppression system is limited by what agent is being used, and how much agent is available for discharge onto the fire. Additionally, currently used fire suppression methods have various disadvantages. For instance, chemical suppressants and water are not effective against all types of fire, can be toxic, and/or be damaging to the surrounding equipment or area. Additionally, these types of suppressants require a physical delivery system which may not be practical aboard ships or aircraft.

Electromagnetic fire control systems have been previously utilized to suppress fires. Schneider Laboratories, with support from the Air Force Research Laboratory, developed an electromagnetic fire suppression system utilizing an antenna coil with a capacitor, a power transfer system, and a power supply (this system is not admitted to be prior art with respect to the present invention). The power transfer system utilizes a spark gap along with the antenna coil to generate an electromagnetic pulse. The pulse is directed toward the fire and utilizes short pulses over relatively long distances. In this system, the antenna coil is deemed by Schneider Laboratories to be the most important component of the device. The system is a one point source with short pulses sent to suppress the fire.

U.S. Pat. No. 5,090,482, issued to Baron et al. and entitled “Method and Apparatus for Extinguishing Fires,” teaches a method of extinguishing fires by generating an intense electric field and/or a gaseous plasma (this patent is not admitted to be prior art with respect to the present invention). The method and apparatus utilize a plasma jet (a high density plasma mixture) which requires injecting ionized gas via a nozzle or funnel into the area.

U.S. Pat. No. 7,104,337, issued to Jones and entitled “Electromagnetic Fire Control and Extinguishing Device,” teaches a system that utilizes the flame as a virtual electrode (this patent is not admitted to be prior art with respect to the present invention). It allows the fire's own electrostatic field to repel the fire's flame.

The present invention does not utilize a one point source with short pulses, a plasma jet, or use the flame as a virtual electrode.

### SUMMARY

The present invention is directed to an electromagnetic fire control system that meets the needs enumerated above and below.

The present invention is directed to an electromagnetic fire control system that includes a conductive surface and a power source such that the power source supplies power so that the conductive surface generates an electric field, the electric field is manipulated and interacts with a fire such that the fire is controlled.

It is a feature of the present invention to provide an electromagnetic fire control system that controls fires without use of any gases or liquids.

It is a feature of the present invention to provide an electromagnetic fire control system that is not limited by the amount of agent available.

It is a feature of the present invention to provide an electromagnetic fire control system that is relatively not toxic, operates on all types of fires, and is not damaging to surrounding equipment when compared to other types of fire control systems.

### DRAWINGS

These and other features, aspects, and advantages of the present invention will become better understood with reference to the following description and appended claims, and accompanying drawing wherein:

FIG. 1 is an embodiment of the electromagnetic fire control system.

### DESCRIPTION

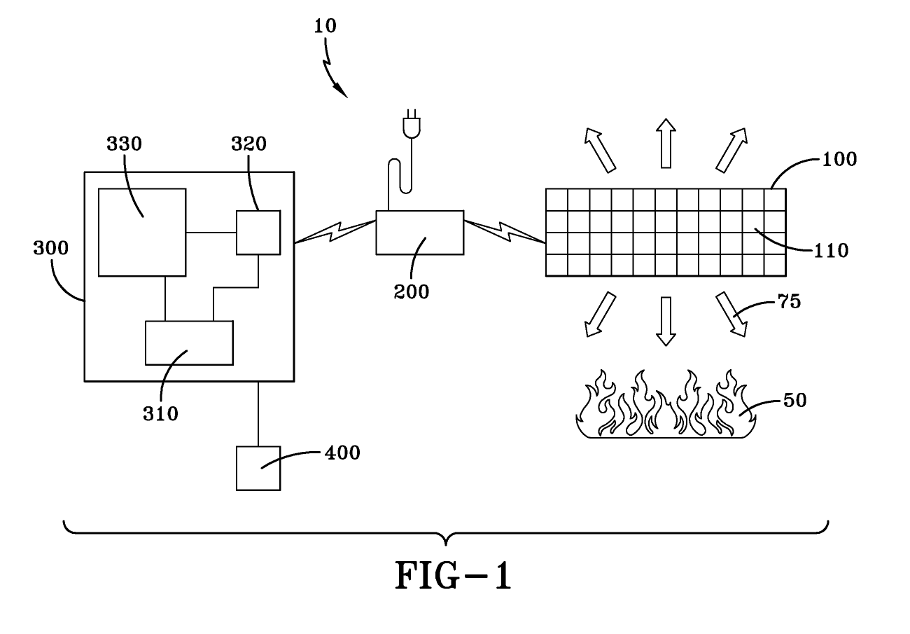

The preferred embodiment of the present invention is illustrated by way of example below and in FIG. 1. As shown in FIG. 1, the electromagnetic fire control system 10 includes a conductive surface 100 and a power source 200 such that the power source 200 supplies power so that the conductive surface 100 generates an electric field 75, the electric field 75 is manipulated and interacts with a fire 50 such that the fire 50 is controlled.

In the description of the present invention, the invention will be discussed in a military environment; however, this invention can be utilized for any type of application that requires use of a fire control system.

As shown in FIG. 1, in one of the embodiments, the conductive surface 100 is an array of grids. The conductive surface 100 may be, but without limitation, a metal surface, a semiconductor, or any type of conductive surface. In one of the preferred embodiments, as shown in FIG. 1 the conductive surface is a wire mesh 110.

In one of the embodiments, in operation, a plug-in power source 200 supplies electricity to the wire mesh 110. The wire mesh 110 generates a multi-directional electric field 75. The electric field 75 is directed toward a fire 50 or flame source. The electric field 75 interacts with the fire 50 or flame source and creates an ionic wind effect which strains the fire to the point of extinction. The system may include a control system 300 that can change the strength of the electric field 75. Additionally, the system may include a detection system 400 that detects fires and/or can provide feedback to determine the strength of the electrical field 75.

In one of the embodiments, the control system 300 may include interface electronics 310, an instrumentation controller 320, and microcontroller/computer 330. These components communicate with each other and the wire mesh 110 such that the strength of the electric field 75 can be changed or manipulated.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. An electromagnetic fire control system, comprising:
a conductive surface;
a power source such that the power source supplies power so that the conductive surface generates an electric field, the electric field is manipulated and interacts with a fire such that the fire is controlled.

2. The electromagnetic fire control system of claim 1, wherein the conductive surface is an array of grids.

3. The electromagnetic fire control system of claim 1, wherein the conductive surface is a metal surface.

4. The electromagnetic fire control system of claim 3, wherein the conductive surface is a wire mesh.
